(19) United States
(12) Patent Application Publication
(10) Pub. No.: US 2013/0018933 A1
(43) Pub. Date: Jan. 17, 2013

(54) Data Shifter and Control Method Thereof, Multiplexer, Data Sifter, and Data Sorter

(71) Applicant: Kazunori Asanaka, Yokohama (JP)

(72) Inventor: Kazunori Asanaka, Yokohama (JP)

(73) Assignee: TELEFONAKTIEBOLAGET LM ERICSSON (PUBL), Stockholm (SE)

(21) Appl. No.: 13/636,360

(22) PCT Filed: Mar. 31, 2010
(86) PCT No.: PCT/JP2010/056269

§ 371 Date: Sep. 21, 2012

(51) Int. Cl. G06F 7/00

(52) U.S. Cl. 708/209

(57) ABSTRACT

A data shifter (10) includes plural stages each including N elemental units (20), each preliminarily assigned a one-bit value c and a positive integer q. The mth elemental unit in the pth stage inputs target data and destination data representing a lane number where Data(p,m), a logical OR of the input target data, should be routed to; compares the qth bit from the LSB of Des(p,m), a logical OR of the input destination data, with the c; and outputs, based on the comparison result, both Data(p,m) or the value 0 and Des(p,m) or the value 0 bound for the mth elemental unit in the next stage, and if m−1+2^{q-1}<N, further outputs both the other of Data(p,m) and the value 0 and the other of Des(p,m) and the value 0 bound for the (m+2^{q-1})th elemental unit in the next stage. The shifter inputs both the N-lane data sequences to be processed as the target data and the destination data of each data sequence into the N elemental units in the first stage, and outputs, as shifted output data of the mth lane, a logical OR of the target data which the elemental units in the last stage output bound for the mth elemental unit in the next stage.

### TECHNICAL FIELD

The present invention relates to a data shifter and a control method thereof, a multiplexer, a data sifter, and a data sorter, and in particular to, but not limited to, a data spreading shifter and a data stuffing shifter.

### BACKGROUND

The required processing speed of digital circuits is increasing year by year. However, improvements in the clock frequency of baseband chips have been slower than increases in the required processing speed. Moreover, parallel processing techniques for baseband chips have been studied in order to improve their processing speed.

Vector processing is a key technique for realizing parallel processing. Insertion and removal of data elements depending upon mask bits play an important role in the implementation of vector processing.

FIG. 1 schematically illustrates the insertion of zeros into input data in accordance with the mask bits. In FIG. 1, the input data consist of six lanes, which are represented by #0 to #5. In the example of FIG. 1, two “zero data” are inserted into the input data. The mask/enable bits specify each insertion position of the zero data using bit 0. Therefore, each of the input data #0 to #5 are moved to the position where bit 1 is assigned and the zero data is inserted into the position where bit 0 is assigned. As is easily seen in FIG. 1, the input data is “spread” to some blocks. Thus, we call this processing data spreading shift.

FIG. 2 schematically illustrates the removal of some data elements from the input data in accordance with the mask bits. In FIG. 2, the input data consist of eight lanes, which are represented by #0 to #7. In the example of FIG. 2, two data elements of the input data are removed, and rest of the data elements are packed into a data sequence. The mask/enable bits specify each removal position of the data elements using bit 0. Therefore, data elements that are assigned the bit 0, that is, data elements #1 and #4 in this example, are removed; other data elements #0, #2, #3, and #5-#7 are collected. Since this processing resembles data stuffing, we call this processing data stuffing shift.

FIG. 3 illustrates a conventional multiplexer to insert zero elements in arbitrary position, which we call a conventional data spreading shifter. FIG. 4 illustrates a conventional data multiplexer for the removal of arbitrary elements, which we call a conventional data stuffing shifter. These conventional multiplexers are constructed with a circuit size given by O(N²), where N is the number of data lanes, and thus this implementation is inefficient.

GB 2 370 384 A discloses an N-bit shifter which receives as its input a sequence of N bits x₀ . . . X_{N-1} and gives as its output a plurality of bits z₀ . . . Z_{N-1} representing a selected permutation transposition or rearrangement of the input bits. This shifter can be constructed with circuit size of O(N log N), and can perform the data spreading/stuffing shift in O(log N) steps.

The shifter of GB 2 370 384 A includes a memory and N one-bit slices of the multiplexers. First, N-bits of input data are stored into the memory. Next, each slice receives one single bit of data stored in a memory area corresponding to the slice and at least one bit of data stored in other memory areas as the input, and selects any one of the input bit data in accordance with a selection signal. More specifically, for 0≦i<N, the slice #i receives one bit of data stored in the memory area #i, which corresponds to the ith slice, and bit data stored in the memory area #(i±2^{k}) (k: nonnegative integer), and then selects and outputs any one of the input bit data in accordance with the selection signal. For each processing cycle, the N slices perform such operations respectively, and then N bit data output by the N slices are stored in the memory. Then, the N slices perform similar operations on the stored N bit data repeatedly until a desired permutation transposition or rearrangement of the input bit data is achieved.

GB 2 370 384 A discloses an embodiment of the shifter that operates as a data stuffing shifter where for k=0, 1, . . . , (log₂ N)−1 and for i=0, . . . , N−1, at the (k+1)th processing cycle, the slice #i selects and outputs a bit data stored in the memory area #i, which corresponds to the slice #i, or bit data stored in the memory area #(i±2^{k}). This shifter requires only O(log N) processing steps, and the circuit size is O(N log N). GB 2 370 384 A also discloses an embodiment of the shifter as a data spreading shifter with O(log N) processing steps based on a similar idea. In addition, GB 2 370 384 A discloses the possibility of constructing a cascade of O(log N) pluralities of N slices, which allows a “select” to be carried out in one single step.

The data spreading/stuffing shifter described in GB 2 370 384 A requires input of a selection signal into each slice every processing cycle. However, it would be burdensome to determine proper selection signals to be input into the slices for each processing cycle. This is because the shifter of GB 2 370 384 A repeatedly performs bit selection at each slice, writes the selected bits into the memory, and performs the bit selection on the bits stored in the memory again.

Therefore, the processing load during the determination of the proper selection signals can become a “bottleneck” in a series of signal processing. GB 2 370 384 A also discloses a cascade of slices to improve the processing speed. However, a simple implementation of the cascade requires a large processing circuit of size O(N log² N).

### SUMMARY

Accordingly, the present invention provides a technology for achieving a fast, easily controlled data spreading/stuffing shifter implementable with small circuit size.

According to one aspect of the present invention, a data shifter that performs data shift operations on N-lane data sequences is provided. The data shifter includes a plurality of stages each of which includes N elemental units. The mth elemental unit, which is included in the pth stage, is preliminarily assigned a predetermined one-bit value c and a positive integer q, and includes

means for inputting target data to be processed whose size is greater than or equal to one bit;

means for inputting destination data representing a lane number of a lane where Data(p,m), a logical OR of the input target data, should be routed to, the size of the destination data being ┌log₂ N┐ bit(s);

means for comparing the qth bit from the least significant bit of Des(p,m), a logical OR of the input destination data, with the one-bit value c; and

means for outputting, based on the comparison result, both one of Data(p,m) and the value 0 as the target data and one of Des(p,m) and the value 0 as the destination data bound for the mth elemental unit included in the next stage, and if m−1+2^{q-1}<N, further outputting both the other of Data(p,m) and the value 0 as the target data and the other of Des(p,m) and the value 0 as the destination data bound for the (m+2^{q-1})th elemental unit included in the next stage.

The data shifter inputs both the N-lane data sequences to be processed as the target data and the destination data of each data sequence into the N elemental units included in the first stage respectively, and outputs, as shifted output data of the mth lane, a logical OR of the target data which the elemental units included in the last stage output bound for the mth elemental unit included in the next stage.

We can construct a data spreading/stuffing shifter according to the present invention, which includes a control circuit whose size is O(N log N) and which requires only O(1) processing step. Thus, the present data shifter is exceedingly efficient compared to GB 2 370 384 A. In addition, predetermined parameters are preliminarily assigned to each elemental unit, which allows easy control of the data shifter and implementation of the shifter with little effort.

Further features of the present invention will become apparent from the following description of exemplary embodiments with reference to the attached drawings.

### BRIEF DESCRIPTION OF DRAWINGS

FIG. 1 schematically illustrates the insertion of zeros into input data in accordance with mask bits.

FIG. 2 schematically illustrates the removal of data elements from input data in accordance with mask bits.

FIG. 3 schematically illustrates a conventional data spreading shifter.

FIG. 4 schematically illustrates a conventional data stuffing shifter.

FIG. 5 schematically illustrates an example of data spreading sequences according to an embodiment of the present invention.

FIG. 6 schematically illustrates an example of data stuffing sequences according to an embodiment of the present invention.

FIG. 7 schematically illustrates an example of switch controls and routing path for data spreading shifter according to an embodiment of the present invention.

FIG. 8 schematically illustrates an exemplified circuit of elemental unit for data spreading/stuffing shifter according to an embodiment of the present invention.

FIG. 9 schematically illustrates an 8-lane data spreading shifter including elemental units according to an embodiment of the present invention.

FIG. 10 schematically illustrates an 8-lane data stuffing shifter including elemental units according to an embodiment of the present invention.

FIG. 11 schematically illustrates an example of multiplexing two data sequences into a single data sequence with data spreading shift.

FIG. 12 schematically illustrates an example of sifting a data sequence into a plurality of data sequences with data stuffing shift.

FIG. 13 schematically illustrates an example of 8×8 full crossbar switches.

FIGS. 14A and 14B schematically illustrate an example of 32×32 full crossbar switches.

FIG. 15 schematically illustrates an example of 32×4 full crossbar switches.

FIG. 16 schematically illustrates an example of multi-port register file with 4 read ports and two write ports.

FIG. 17 a flowchart of an exemplified processing procedure executed by a data shifter according to an embodiment of the present invention.

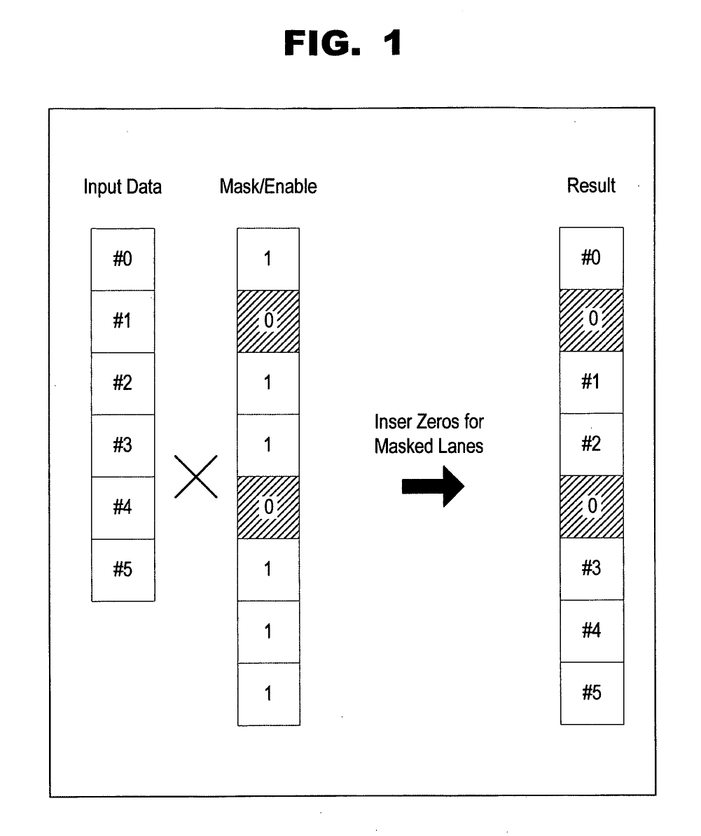

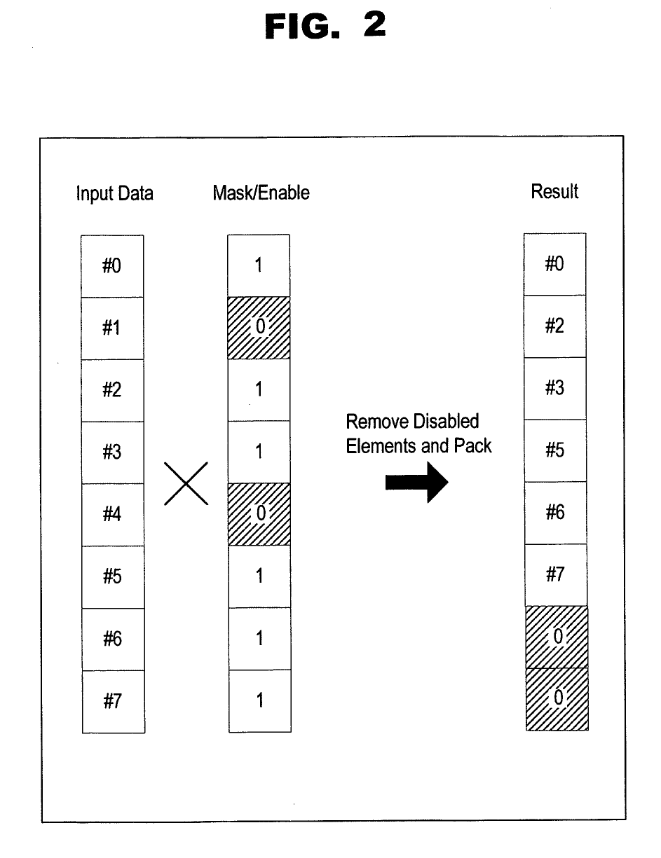

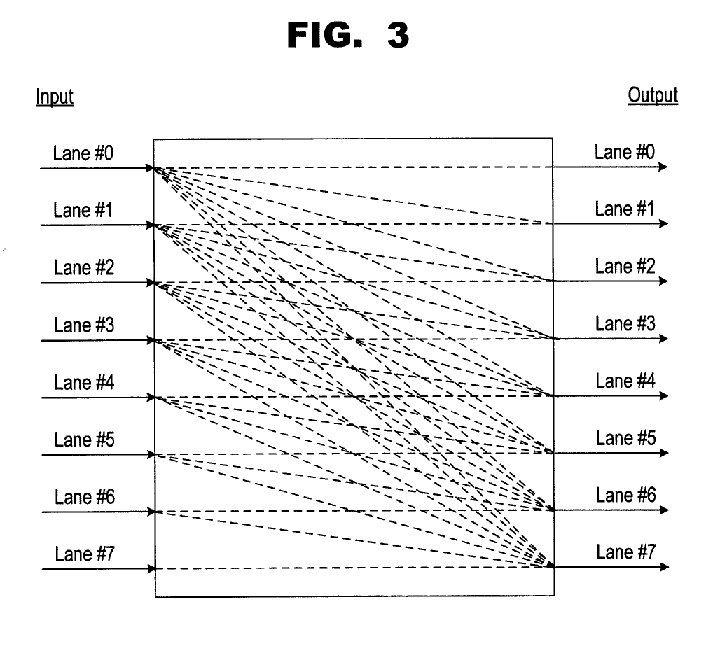

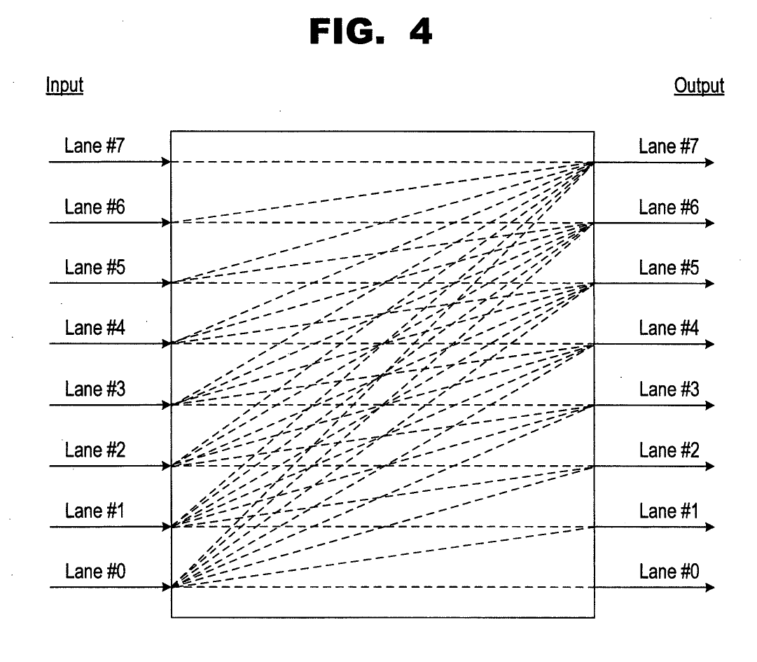

### DETAILED DESCRIPTION

Embodiments of the present invention will now be described with reference to the attached drawings. Each embodiment described below will be helpful in understanding a variety of concepts from the generic to the more specific. It should be noted that the technical scope of the present invention is defined by claims, and is not limited by each embodiment described below. In addition, not all combinations of the features described in the embodiments are always indispensable for the present invention.

### (Overview)

The data shifter according to an embodiment of the present invention is based on a barrel shifter constructed with a number of stages of binary multiplexers. The spreading/stuffing shifter is realized by controlling each of a plurality of switches in the multiplexers.

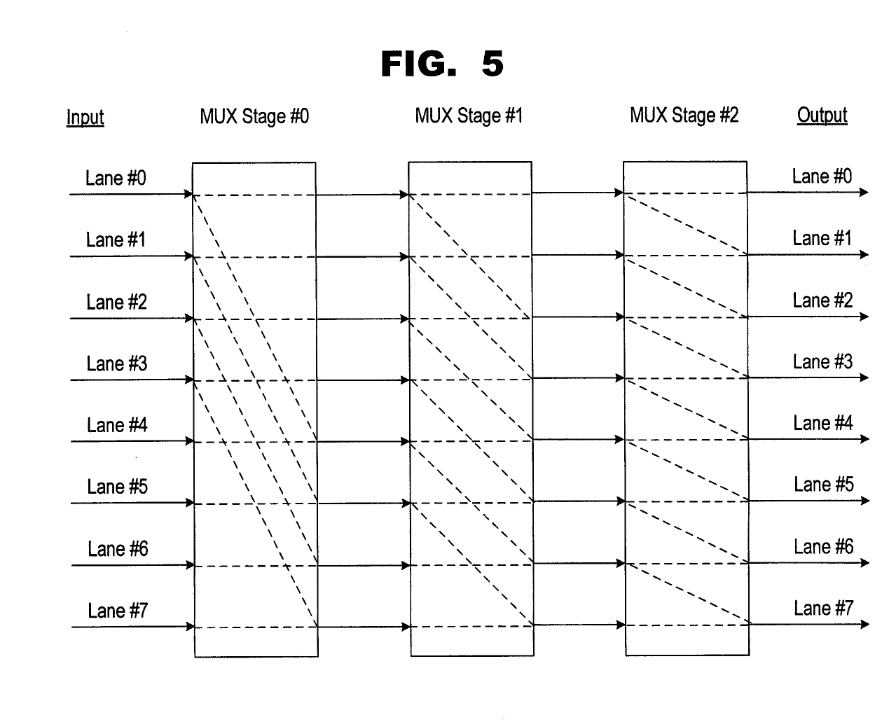

FIG. 5 illustrates data lanes for data spreading shifter with N (=8) lanes according to the embodiment of the present invention. The data spreading shifter is constructed with a plurality of stages. Each stage includes a multiplexer (MUX) for selecting one of two input lanes and outputting the selected one such that if necessary, the MUX #p shifts the data by 2^{┌log}^{₂}^{N┐-1-p} lanes. More specifically, the stage #p (p=0, 1, . . . . , ┌log₂ N┐−1) selects, for m=0, . . . , (N−1−2^{┌log}^{₂}^{N┐-1-p}), one of lane #m and lane #(m+2^{┌log}^{₂}^{N┐-1-p}), and outputs the input data of the selected lane as an output for lane #(m+2^{┌log}^{₂}^{N┐-1-p}). In addition, for m=0, . . . , (N−1−2^{┌log}^{₂}^{N┐-1-p}), if lane #m is selected as the output for lane #(m+2^{┌log}^{₂}^{N┐-1-p}), zero data (i.e., data wherein all bits have value zero) is output as an output for lane #m; otherwise the input data of lane #m is output as the output for lane #m. As will be described later, it is possible to achieve any form of desired data spreading uniquely by controlling each of the MUXs to shift the input data adequately.

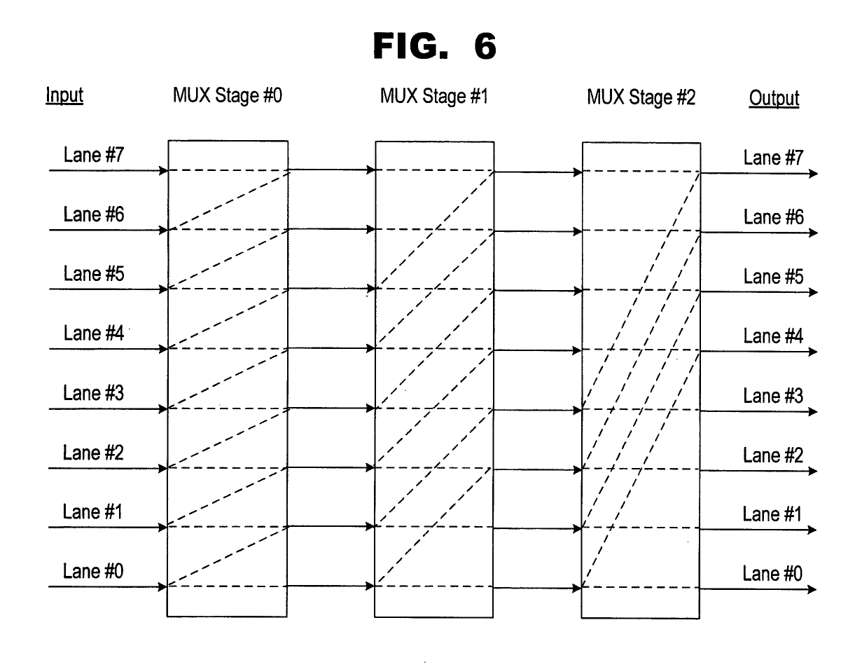

The data stuffing shifter can be constructed as in FIG. 6. FIG. 6 illustrates data lanes for a data stuffing shifter with N (=8) lanes according to the embodiment of the present invention. The multiplexer stages are connected in reverse order of the data spreading shifter. That is, when necessary, the MUX #p shifts the data of a given lane by 2^{p} lanes. More specifically, the stage #p (p=0, 1, . . . , ┌log₂ N┐−1) selects, for m=0, . . . , (N−1−2^{p}), one of lane #m and lane #(m+2^{p}), and outputs the input data of the selected lane as an output for lane #m. In addition, for m=0, . . . , (N−1-2^{p}), if lane #m is selected as the output for lane #(m+2^{p}), zero data is output as the output for lane #m; otherwise, the input data of lane #m is output as the output for lane #m. As will be described later, it is possible to achieve any form of desired data stuffing uniquely by controlling each of the MUXs to shift the input data adequately.

The above data spreading/stuffing shifter can be constructed with the circuit size of O(N log N). Note that if the order of multiplexer stages is reversed (i.e., swapping the data spreading shifter and data stuffing shifter), a collision of routing resources could occur.

### (Basic Control of Switches)

The structure for data lanes of a spreading/stuffing shifter according to the embodiment of the present invention has been described above as a basic concept. Now, a description will be provided regarding how switches may be controlled and how collisions of routing resources may be avoided.

Let us assume that the number of the stages of multiplexers is M and an input lane #u is to be shifted to an output lane #v. Then, the difference A of the input lane number and the output lane number can be represented as

$$Δ = v - u = {\sum }_{i = 0}^{N - 1} {2}^{i} {b}_{i} ( b ∈ \{ 0 , 1 \} ) .$$

Therefore, the routing of the signal can be performed by setting the switch

$$\# {S}_{n} ( u , v ) = v - {\sum }_{i = 0}^{n - 1} {2}^{i} {b}_{i} = v - ( Δ mod {2}^{n} )$$

to bₙ. Here, switch #Sₙ(u,v) shifts input data by 2ⁿ lanes if its input data value is 1, otherwise it does not shifts and outputs the input data as it is. In other words, the switches shift their input data by 2ⁿ if bₙ is 1.

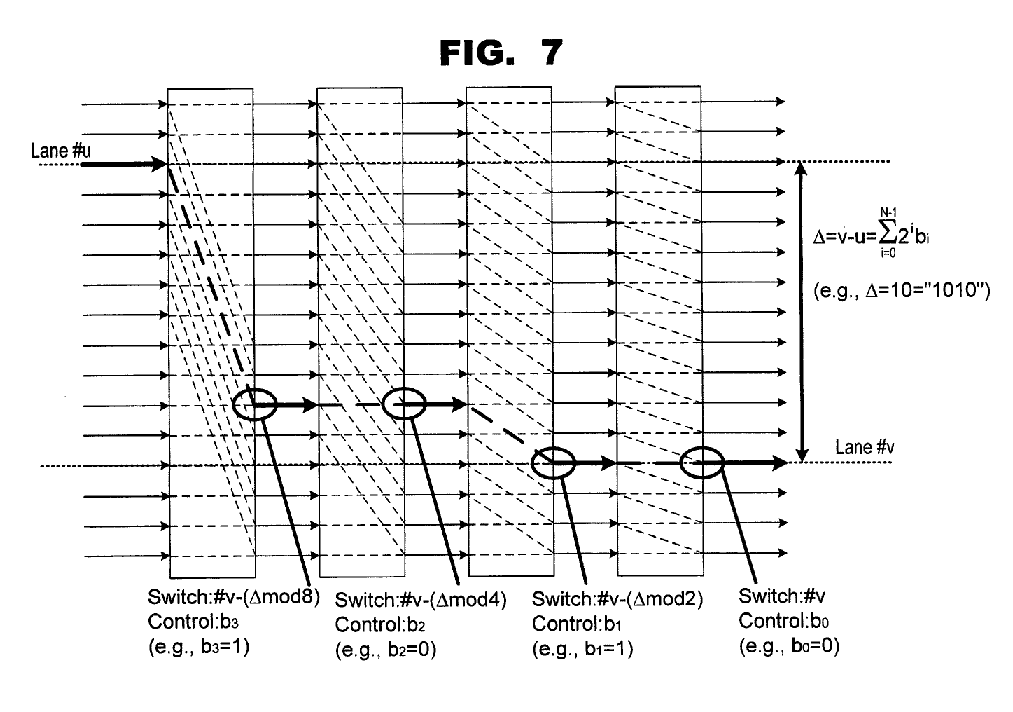

FIG. 7 schematically illustrates an example of switch controls and a routing path for a data spreading shifter. The mappings of input and output lanes are determined as described above. FIG. 7 shows which switches should be turned on when the combination of input and output lanes is determined. In the example of FIG. 7, input data of lane #u=#2 is routed to lane #v=#12. Here, Δ=v−u=(10)₁₀=(1010)₂. Thus, (b₃, b₂, b₁, b₀)=(1,0,1,0), and both the first MUX, which is adapted to shift input data by 2³ lanes, and the third MUX, which is adapted to shift input data by 2¹ lanes, are activated to shift the input data. The routing path is shown as in FIG. 7. Note that the switches for a data stuffing shifter can be controlled in the same manner.

### (Collision of Routing Resources)

Mathematically, it is possible to prove that the data can be routed without any collision of routing resources when we use a certain ordering of the multiplexer stages. For this routing, it is possible to prove that the collision of routing resources will not occur for the following two routes.

a) from input lane #u to output lane #v.

b) from input lane #u+1 to output lane #v+1+a (a≧0)

### Proof:

Let us assume β and γ are integers and that:
u−v=2ⁿβ+γ (0≦γ<2ⁿ). Then, it follows:

$$\begin{matrix}{S}_{n} ( u + 1 , v + 1 + α ) - {S}_{n} ( u , v ) = ( v + 1 + α ( ( v + α - u ) mod {2}^{n} ) ) - \\ ( v - ( ( v - u ) mod {2}^{n} ) ) \\ = 1 + α - ( ( {2}^{n} β + γ + α ) mod {2}^{n} ) + \\ ( ( {2}^{n} β + γ ) mod {2}^{n} ) \\ = 1 + ( γ + α ) - ( ( γ + α ) mod {2}^{n} ) \\ \geq 1\end{matrix}$$

$$Q . E . D .$$

In the same manner, we can prove routing resource collisions cannot occur.

### (Control of Switches for Implementation)

In the basic control method of switches described with reference to FIGS. 5-7, it is necessary to input mask/enable information for all data lanes just to set the state of the switches. It is possible to see the width of the data lane as O(1), that is, a certain constant. The bit width of the control signal such as the destination signal is narrower than that for a data lane and it also can be seen as the width of O(1). In this assumption, the number of switches of the data shifter according to the embodiment of the present invention is O(N log N) switches and the data shifter can be constructed with the circuit size of O(N log N). However, we need to generate O(N log N) control signals for O(N log N) switches. Simply, a control signal can be generated by N destinations corresponding to N inputs. The circuit size for generating all control signals will be O(N² log N), although the switches can be constructed with a circuit size of O(N log N). Therefore, it is necessary to have an optimized method to control the switches.

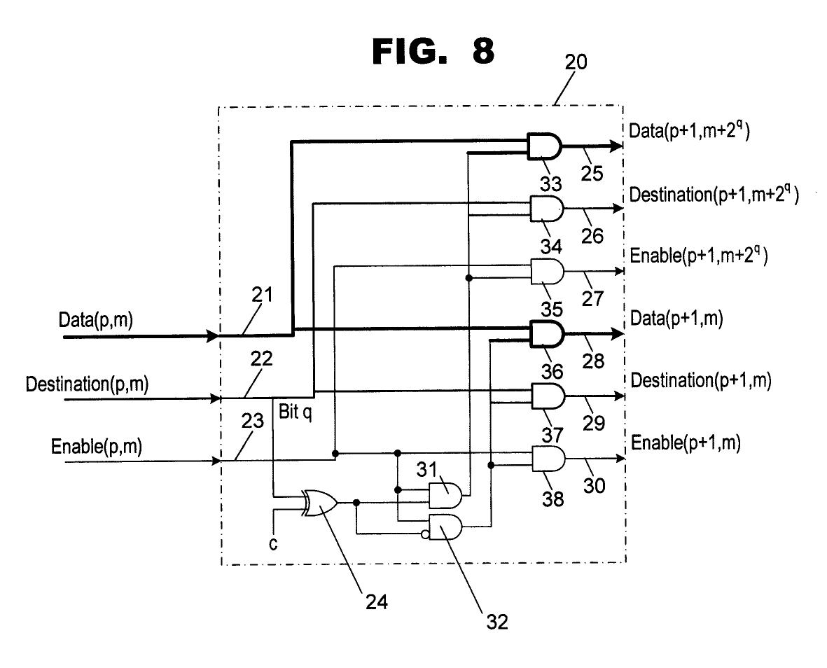

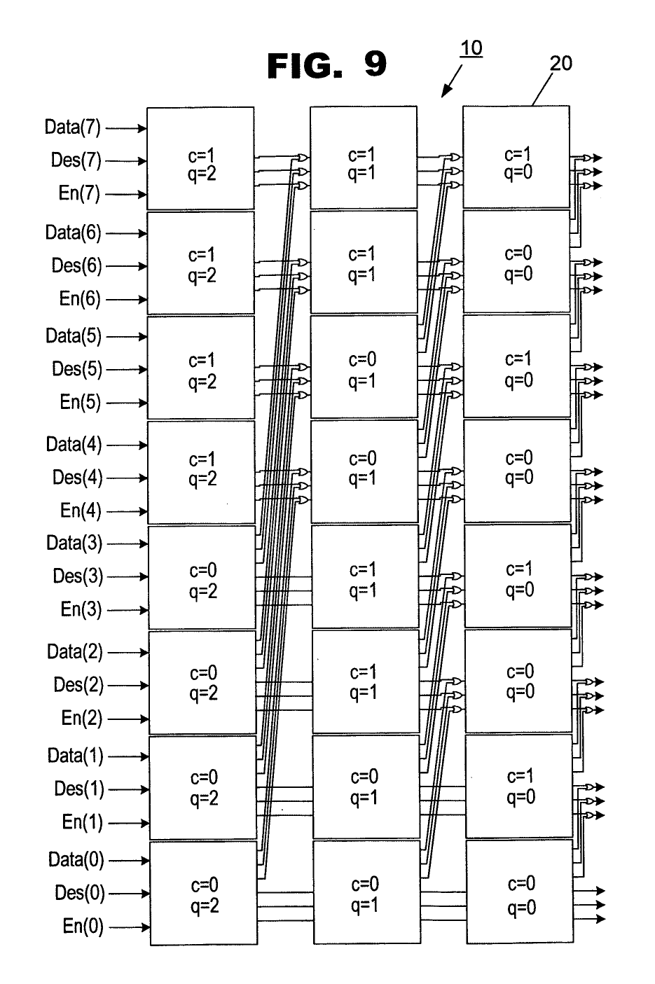

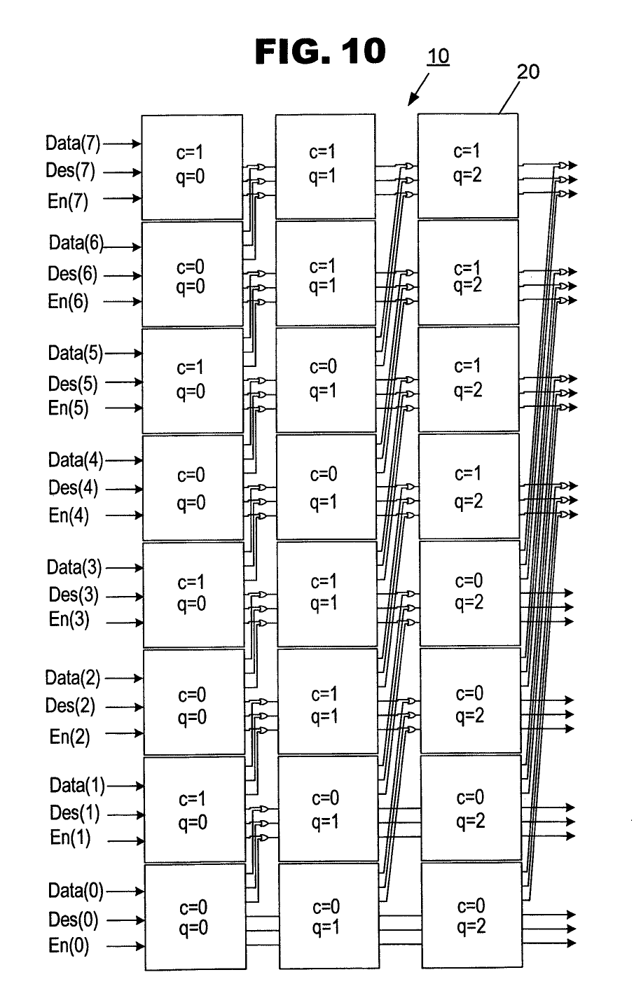

Accordingly, we introduce an elemental unit 20, as depicted in FIG. 8, which includes circuits for the data lanes and controls. The data shifter 10 according to the embodiment of the present invention includes a plurality of elemental units 20 as shown in FIGS. 9 and 10. The plurality of elemental units 20 are arranged in a matrix pattern in order to perform as the data spreading/stuffing shifter described above. In FIGS. 9 and 10, we call each set of elemental units 20 in the same column a stage. N-lane data sequences to be processed as target data together with information identifying the destination lane of the data are input into the elemental units 20 in the first stage. For N-lane data sequences, the data shifter 10 includes ┌log₂ N┐ stages each of which includes N elemental units 20. The final stage, that is, the stage #(┌log₂ N┐−1) outputs the result of shift operations on the input data sequences.

### (Elemental Unit)

As shown in FIG. 8, the elemental unit 20 includes input circuits 21-23 for target data, destination data of the target data, and enabler signals. The input circuit 21 inputs target data to be processed whose size is greater than or equal to one bit. We represent the target data, which is input into the #m of elemental unit 20 included in the stage #p, as Data(p,m). It should be noted that one elemental unit 20 may input multiple target data from multiple elemental units in the preceding stage. In such a case, the elemental unit 20 inputs a logical OR of the multiple target data as Data(p,m). For all p and m, the bit width of Data(p,m) is identical. That is, the bit width of each lane data of the N-lane data sequences is identical.

The input circuit 22 inputs destination data representing a lane number of the lane to which Data(p,m) should be routed. The size of the destination data is ┌log₂ N┐ bit(s). We represent the destination data input into the #m of elemental unit 20 in the stage #p as Destination(p,m) or Des(p,m). The input circuit 23 inputs one-bit enabler signals. When the input circuit 23 inputs a zero bit as the enabler signal, the elemental unit 20 and its subsequent elemental units are disabled. We represent the enabler signal input into the #m of elemental unit 20 in the stage #p as Enable(p,m).

Each elemental unit 20 is preliminarily assigned a predetermined one-bit value c and a nonnegative integer q. The bit length of the integer q is ┌log₂┌log₂ N┐┐. The elemental unit 20 compares the bit #q from the least significant bit (LSB) of Des(p,m), a logical OR of the input destination data, with the value c. Then, the elemental unit 20 outputs, based on the comparison result, both (i) one of Data(p,m) value and the value 0 as the target data and (ii) one of Des(p,m) value and the value 0 as the destination data bound for the elemental unit #m in the next stage. In addition, if m+2^{q}<N, the elemental unit 20 further outputs both the other of Data(p,m) value and the value 0 as the target data and the other of Des(p,m) and the value 0 as the destination data bound for the elemental unit #(m+2^{q}) in the next stage.

More specifically, the data shifter 20 according to the present embodiment includes an exclusive OR circuit 24, a plurality of AND circuits 31-38, and a plurality of output circuits 25-30. The exclusive OR circuit 24 performs the exclusive OR arithmetic operation on the bit #q of Des(p,m) value and the bit #c, and outputs the resulting bit to the AND circuit 31 and the inverted resulting bit to the AND circuit 32. The AND circuit 31 performs the AND arithmetic operation on Enable(p,m) value and the output of the exclusive OR circuit 24, and outputs the result to each of the AND circuits 33-35. Similarly, the AND circuit 32 performs the AND arithmetic operation on Enable(p,m) value and the inverse of the output of the exclusive OR circuit 24, and outputs the result to each of the AND circuits 36-38.

The AND circuit 33 performs the AND arithmetic operation on each bit of Data(p,m) and the output of the AND circuit 31, and outputs the result to the output circuit 25. Similarly, the AND circuit 34 performs the AND arithmetic operation on each bit of Des(p,m) and the output of the AND circuit 31, and outputs the result to the output circuit 26. The AND circuit 35 performs the AND arithmetic operation on each bit of Enable(p,m) and the output of the AND circuit 31, and outputs the result to the output circuit 27. Note that if m+2q<N, the output circuit 25 transfers the output of the AND circuit 33 as the target data bound for the elemental unit #(m+2q) in the next stage. If m+2^{q}≧N, the output circuit 25 is terminated. Similarly, if m+2^{q}<N, the output circuits 26 and 27 transfer the output of the AND circuits 34 and 35 as the destination data and the enabler signal respectively bound for the elemental unit #(m+2^{q}) in the next stage. If m+2^{q}≧N, the output circuits 26 and 27 are terminated.

Similar to the AND circuit 33, the AND circuit 36 performs the AND arithmetic operation on each bit of Data(p,m) and the output of the AND circuit 32, and outputs the result to the output circuit 28. Similarly, the AND circuit 37 performs the AND arithmetic operation on each bit of Des(p,m) and the output of the AND circuit 32, and outputs the result to the output circuit 29. The AND circuit 38 performs the AND arithmetic operation on each bit of Enable(p,m) and the output of the AND circuit 32, and outputs the result to the output circuit 30. The output circuit 28 transfers the output of the AND 36 circuit as the target data bound for the elemental unit #m in the next stage. Similarly, the output circuits 29 and 30 transfer the output of the AND circuits 37 and 38 as the destination data and the enabler signal respectively bound for the elemental unit #m in the next stage.

In this way, the #m of elemental unit 20 in the stage #q according to the embodiment of the present invention performs output divided into two cases depending upon whether or not the bit #q from the least significant bit of Des(p,m) matches the bit value c:

(i) if the bit #q from the least significant bit of Des(p,m) does match the value c, both Data(p,m) as the target data and Des(p,m) as the destination data are output bound for the elemental unit #m included in the next stage. If m+2^{q}<N, the elemental unit 20 further outputs the value 0 as both the target data and the destination data bound for the elemental unit #(m+2^{q}) included in the next stage. Otherwise, (ii) if the bit #q from the least significant bit of Des(p,m) does not match the value c, the elemental unit 20 outputs the value 0 as both the target data and the destination data bound for the elemental unit #m included in the next stage, and if m+2^{q}<N, further outputs both Data(p,m) as the target data and Des(p,m) as the destination data bound for the elemental unit #(m+2^{q}) included in the next stage.

As an operational example, if the input circuit 23 inputs Enable(p,m)=0, all of the AND circuits 33-38 output “0” to the output circuits 25-30. Therefore, the elemental unit 20 and its subsequent elemental units, which input 0 (the output of the AND circuit 35 or 38) as the enabler signal, are disabled.

In contrast, if the input circuit 23 inputs Enable(p,m)=1, and if the bit #q of Dest(p,m) matches the bit #c, the output of the exclusive OR 24 is 0, and thus the output of the AND circuit 31 is 0 while the output of the AND circuit 32 is 1. Therefore, in such a case, all of the output circuits 25-27 output 0 while the output circuits 28-30 output Data(p,m), Dest(p,m), and Enable(p,m), respectively. If the input circuit 23 inputs Enable(p,m)=1, and if the bit #q of Dest(p,m) does not match the bit #c, the output of the exclusive OR 24 is 1, and thus the output of the AND circuit 31 is 1 while the output of the AND circuit 32 is 0. Therefore, in such a case, the output circuits 25-27 output Data(p,m), Dest(p,m), and Enable(p,m), respectively, while all of the output circuits 28-30 output 0.

### (Data Shifter)

As already described, the data shifter 10 according to the present embodiment includes a plurality of stages, each of which includes N elemental units 20 in a matrix pattern to perform data shift operations on N-lane data sequences. The data shifter 10 inputs both the N-lane data sequences to be processed as the target data and the destination data of each said data sequence into the N elemental units included in the first stage. Then, the data shifter 10 outputs, as shifted output data of the lane #m, a logical OR of the target data which the elemental units included in the last stage output bound for the elemental unit #m included in the next stage.

As will be plain to those skilled in the art, the assignment of the values c and q determines the operations of the elemental units 20 and the data shifter 10, which includes the plurality of the elemental units. FIG. 9 shows a data shifter 10 which operates as a data spreading shifter with eight lanes. FIG. 10 shows a data shifter 10 which operates as a data stuffing shifter with eight lanes. The destination signal Dest(p,m) comprises ┌log₂ N┐ bits, where bit #(┌log₂ N┐−1) represents the address for the “widest area” and bit #0 represents the address for the most “local area”. It is possible to see this as ┌log₂ N┐ stages of hierarchy of address. In the elemental unit 20, one hierarchy of the address, the bit #q of the destination, is extracted and compared with the value of c which corresponds to the bit #q of present location #m. If the comparison result is mismatch, the shift is performed by the size corresponding to the hierarchy.

The data spreading shifter performs the shift of 2^{┌log}^{₂}^{N┌-1-p} lane in stage #p, as shown in FIG. 9, by comparing the bit #q=#(┌log₂ N┐−1−p) of the destination Dest(p,m) with the value of c. The data stuffing shifter performs the shift of 2^{p} lanes in stage #p, as shown in FIG. 10, by comparing the bit #q=#p of the destination Dest(p,m) with the value of c.

By introducing the elemental unit, we can construct a data spreading/stuffing shifter including a control circuit whose size is O(N log N), which is equal to that of GB 2 370 384 A. More specifically, the gate count of the data shifter according to the present embodiment is O(N log N), and the number of wires is O(N log N). Further, the data shifter according to the present invention requires only O(1) processing step. Thus, the data shifter according to the present embodiment is exceedingly efficient compared to GB 2 370 384 A. In addition, the parameters c and q are preliminarily assigned to each elemental unit 20 and it is unnecessary to control the operations of the elemental units according to the change in operational states of the data shifter 10. This allows easy control of the data shifter 10 and implementation of the shifter 10 with little effort.

### (Multiplexer)

The data spreading/stuffing shifter described above can be applied not only to just insertion or removal of data lane elements but also to various data processing applications. For example, the data spreading shifter according to the present embodiment allows easy implementation of a multiplexer for multiplexing multiple data sequences.

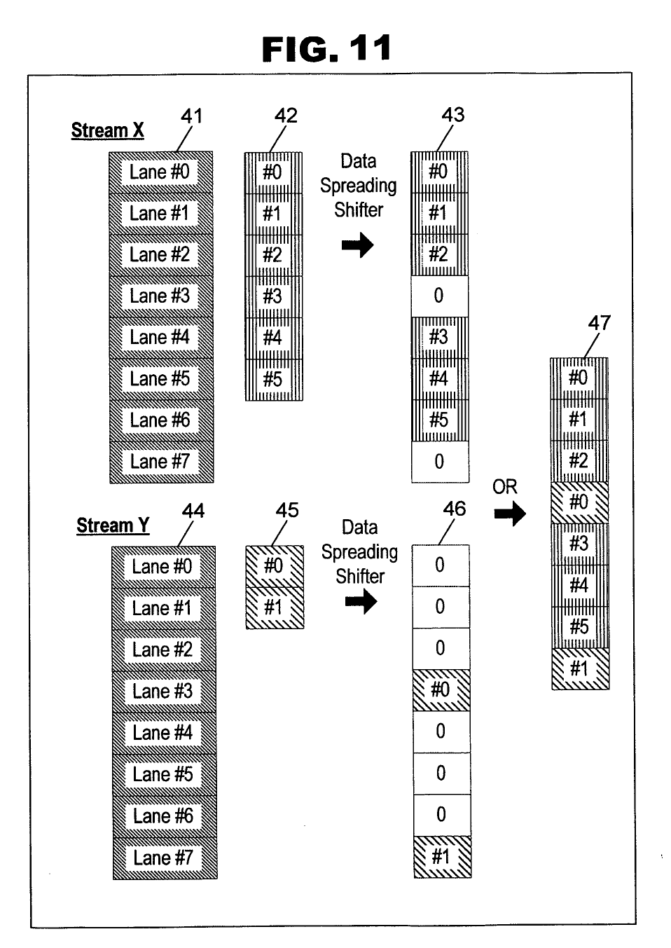

FIG. 11 illustrates an example of a multiplexer for multiplexing two streams utilizing two data spreading shifters. In FIG. 11, the first stream X (41) is spread by the data spreading shifter according to the present embodiment such that the data sequences #0-#5 (42) are moved to lanes #0-#2 and #4-6 and data 0 is inserted into lanes #3 and #7 (43). At the same time, the second stream Y (44) is spread by the data spreading shifter according to the present embodiment such that data sequences #0 and #1 (45) are moved to lanes #3 and #7 respectively, and data 0 is inserted into lanes #0-#3 and #4-#6 (46). Then, the spread streams X and Y are logically added to form a multiplexed stream (47). It should be noted that the data spreading shifter for spreading the stream X and the spreading shifter for spreading the stream Y may be identical or may be provided separately. The computation of the logical OR may be implemented by at least one logical OR circuit(s). The circuit size of the multiplexer based on the data spreading shifter according to the present embodiment is O(N log N) and thus is very small.

### (Data Sifter)

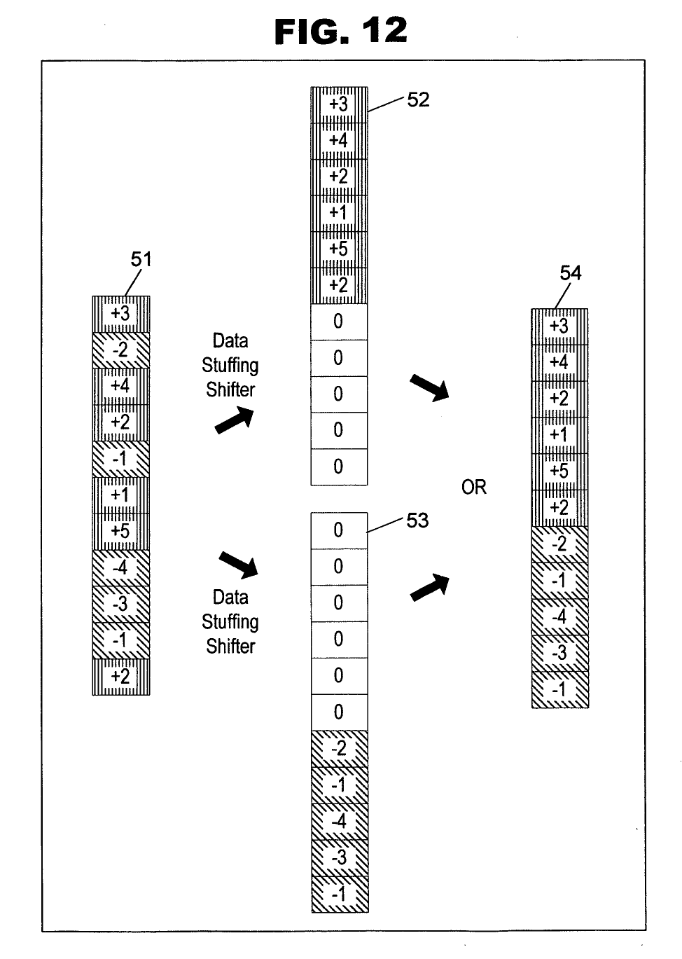

Another application of the data shifter according to the present embodiment is a data sifter for “sifting” each data element Data(m) included in an input data sequence into two groups based on a sort key K(m) corresponding to the data element and a predetermined decision function f(K(m)) which takes the sort key K(m) as the input and outputs a Boolean result. FIG. 12 illustrates an example of a data sifter for sifting data into positive and negative values, utilizing two data stuffing shifters according to the present embodiment. In FIG. 12, an input sequence (51) includes a plurality of data elements whose values are positive or negative. The positive data elements and the negative data elements in the input sequence (51) are sifted into a first group (52) and a second group (53) respectively by the data stuffing shifter according to the present embodiment. In the example of FIG. 12, positive data elements are sifted into the lanes #0-#5, and negative data elements are sifted into lanes #6-#10. Then, the stuffed data sequences (52, 53) are logically added to form a sifted stream (54).

In the example described above, the data stuffing shifter sifts a set of data elements into two groups based on a decision function f(K(m)) which outputs Boolean result by comparing the sort key K(m) with a threshold value 0, but an arbitrary operation can be performed in the decision function. In addition, in the example described above, the data stuffing shifter sifts the data elements in the input data sequence based on the value of said data elements themselves, but the data sifting may be based on any sort key corresponding to the data elements. For example, if the input data sequence is a sequence of memory addresses, the data stuffing shifter may sift the data elements (memory addresses) based on the values of the data elements to which the memory addresses point.

Therefore, the data sifter may sift each data Data(m) element included in an input data sequence into two groups based on sort key K(m) corresponding to said data element and a predetermined decision function f(K(m)) which takes the sort key K(m) as the input and outputs Boolean result. With use of the data stuffing shifter according to the present embodiment, the data sifter may collect data elements where corresponding sort key values let the decision function output “True”, from the data elements included in the input data sequence in order to output a first data sequence. Further, the data sifter may collect data elements where corresponding sort key values let the decision function output “False”, from the data elements included in the input data sequence, with use of the data stuffing shifter according to the present embodiment, to output a second data sequence. As in the previous example, the sort key corresponding to a given data element may be the value of said data itself.

The destination lane number for above stuffing shifter is calculated by counting the data already stuffed for each collection. That is, when we define the result of the decision for lane #m as d(m) and d(m)=0 for positive value, and d(m)=1 for negative value, the destination Des(m) is determined as:

$$Des ( m ) = \{ \begin{matrix}{\sum }_{i = 0}^{m - 1} d ( i ) & ( d ( m ) = 0 ) \\ N - 1 - {\sum }_{i = 0}^{m - 1} d ( m - i ) & ( d ( m ) = 1 )\end{matrix}$$

It should be noted that the data stuffing shifter for sifting the positive data elements and the stuffing shifter for sifting the negative data elements may be identical or may be provided separately. The computation of the logical OR may be implemented by at least one logical OR circuit(s). The circuit size of the data sifter based on the data stuffing shifter according to the present embodiment is O(N log N) and thus is very small.

### (Full Crossbar Switch)

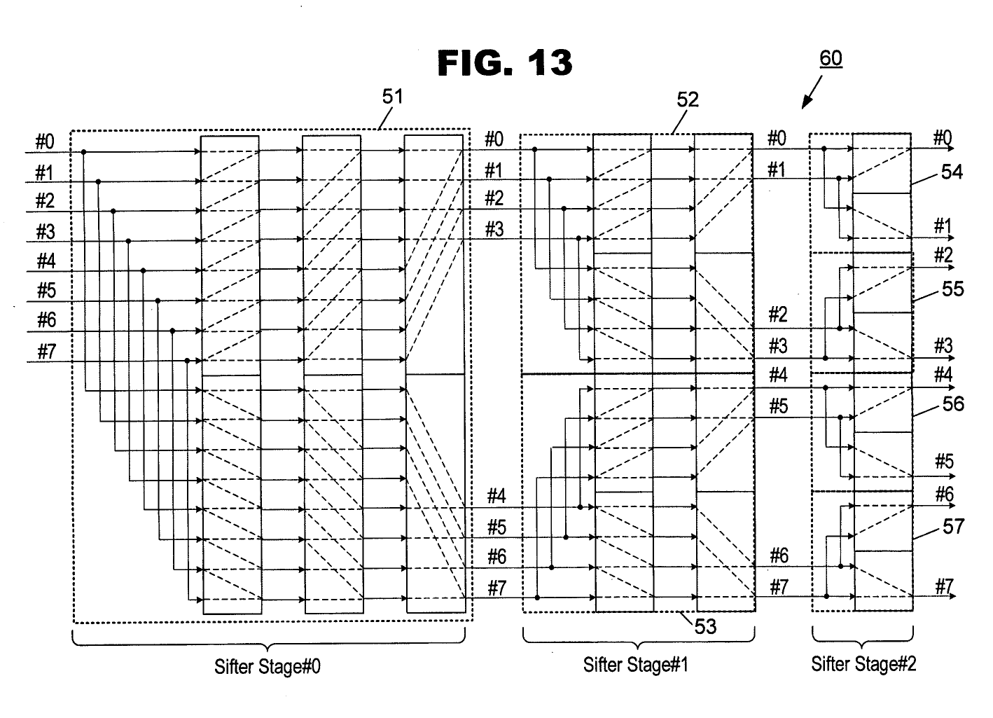

One may construct a data sorter that sorts each data element included in an input data sequence by repeatedly sifting each output of the above described data sifter. FIG. 13 illustrates an example of such a data sorter. As shown in FIG. 13, the data sorter 60 may be built up with a plurality of data sifters 51-57. We call such a data sorter built up with the data shifters a full crossbar switch. The full crossbar switch according to the present embodiment can be constructed with a circuit size of O(N log² N) for N data lanes while conventional crossbar switches typically require a circuit size of 0(N²).

FIG. 13 shows an example of an 8×8 full crossbar switch 60 utilizing three stages of data sifters 51-57. The output lane number may be represented using 3 bits as {0,1, . . . , 6,7}. In the stage #0 (51), if the most significant bit (MSB, that is, bit 2) of the output lane number is zero then the data is moved to one of lanes (0, 1, 2, 3); otherwise, the data is moved to one of lanes {4,5,6,7}. The stage #1 consists of two data sifters 52, 53; one sifter is for handling lanes {0,1,2,3} while the other is for lanes {4,5,6,7}. The stage #2 consists of four data sifters 54-57. In the same manner, the data is sifted depending upon the bit of the output lane number.

In this way, the data sorter according to the present embodiment sorts each data element included in an input data sequence. The data sorter first inputs each data element included in the input data sequence into the data sifter described above, and then performs control to repeatedly input each data element included in the two independent data sequences into the data sifter such that all of the data included in the input data sequence are sorted.

Thus, the full crossbar switch, which is an example of a data sorter, includes a plurality of data sifters. The plurality of data sifters includes one data sifter that inputs the input data sequence as a target data sequence. Each of the plurality of data sifters inputs a target data sequence, sifts the target data sequence into a first and a second data sequence based on the sort key preliminarily assigned to said data sifter, outputs the first and/or second data sequence, including more than one data elements, to another data sifter(s) as the target data sequence, and outputs the first and/or second data sequence, including only one data element, as the sorting result.

One shifter is constructed with circuit size O(N log N) and the full crossbar switch and data sorter can be constructed with O(N log² N).

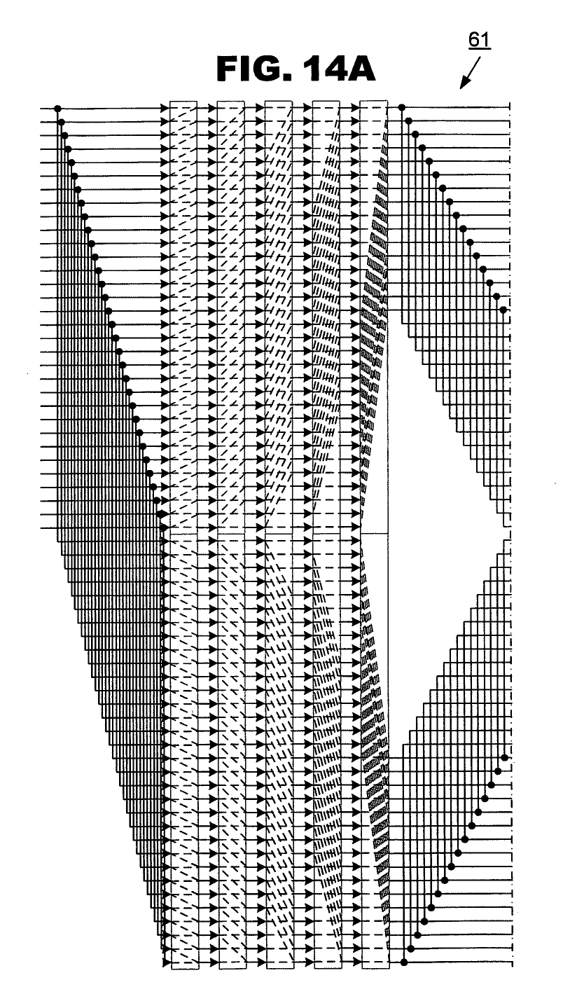

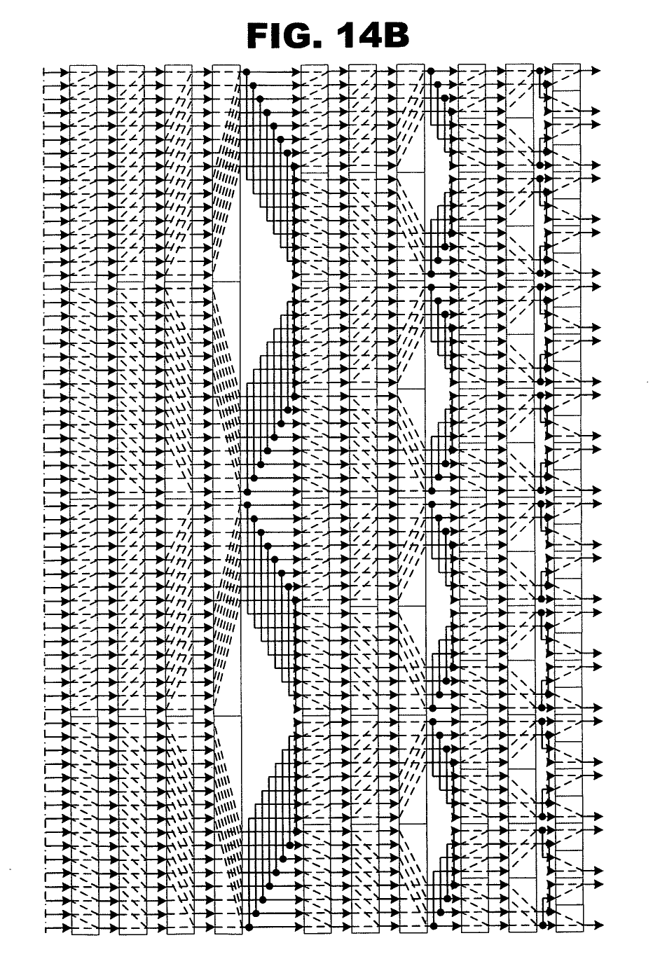

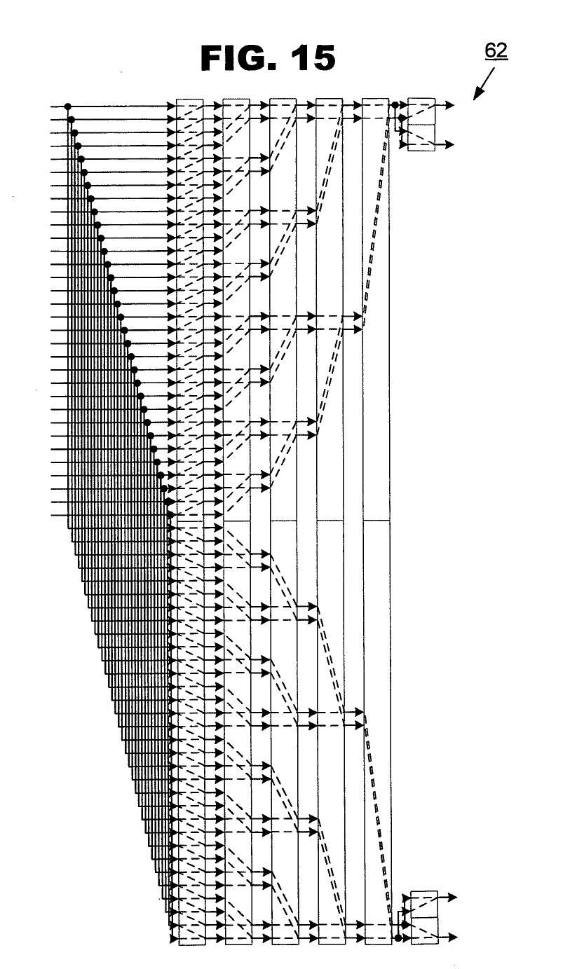

FIGS. 14A and 14B depict a 32×32 full crossbar switch 61, as a larger example. If at least one output is known in advance to be unused in subsequent processing, a number of parts become unnecessary and it is possible to design the crossbar switch with fewer circuits by omitting the unnecessary parts. FIG. 15 shows an example of 32×4 full crossbar switch 62, where the numbers of input and output lanes are different. The full crossbar switch 62 exemplified in FIG. 15 outputs only the largest two data elements and the smallest two data elements.

### (Register File)

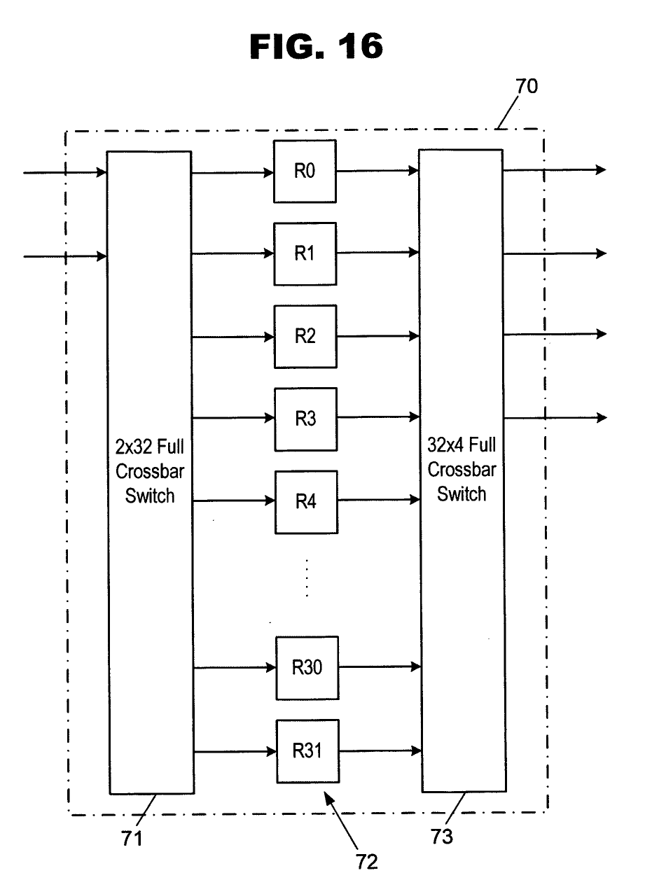

FIG. 16 shows a multi-port register file 70, to which four read ports and two write ports are implemented utilizing the full crossbar switch exemplified in FIG. 15 is applied. The multi-port register file 70 includes a 2×32 full crossbar switch 71, 32 registers (R0-R31) 72, and a 32×4 full crossbar switch 73. Up to two parallel input data are multiplexed by the 2×32 full crossbar switch 71 and written to the registers 72. Up to four parallel read data are multiplexed by the 32×4 full crossbar switch 70 and sent to the output ports.

### (Processing Procedure of Data Shifter)

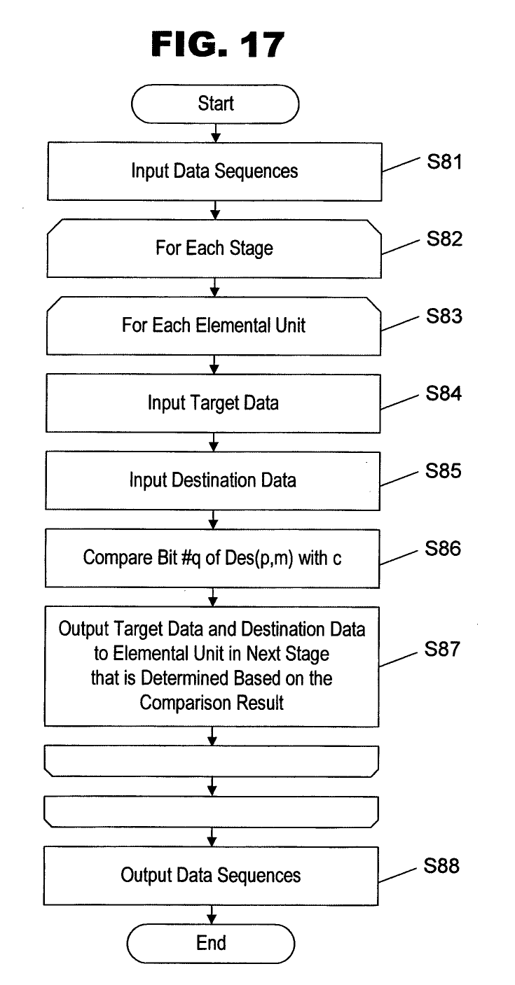

FIG. 17 is a flowchart of the processing procedure executed by the data shifter 10. As described above, the data shifter 10 includes a plurality of stages each of which includes N elemental units 20 to perform data shift operations on N-lane data sequences. The #m of elemental unit 20 included in the stage #p is preliminarily assigned a predetermined one-bit value c and a nonnegative integer q. First, the data shifter 10 inputs both the N-lane data sequences to be processed as the target data and the destination data of each said data sequence into the N elemental units included in the first stage respectively (S81). Then, the data shifter 10 performs the processing of S83-S87 for each stage (S82). The data shifter 10 performs the processing of S84-S87 for each elemental unit included in the active stage.

In S84, the elemental unit 20 inputs target data to be processed of size greater than or equal to one bit. At the same time, the elemental unit 20 inputs destination data representing a lane number of a lane where Data (p,m), a logical OR of the input target data, should be routed to, the size of the destination data being ┌log₂ N┐ bit(s) (S85). Then, the elemental unit 20 compares the bit #q from the least significant bit of Des(p,m), a logical OR of the input destination data, with the bit value c (S86). Based on the comparison result, the elemental unit 20 outputs both (i) one of Data(p,m) and the value 0 as the target data and (ii) one of Des(p,m) and the value 0 as the destination data bound for the elemental unit #m included in the next stage. If m+2^{q}<N, the elemental unit 20 further outputs both the other of Data(p,m) and the value 0 as the target data and the other of Des(p,m) and the value 0 as the destination data, bound for the elemental unit #(m+2^{q}) included in the next stage (S87). After executing the processing of S84-S87 for all elemental units in all stages, the data shifter 10 outputs, as shifted output data of the lane #m, a logical OR of the target data which the elemental units included in the last stage output bound for the elemental unit #m included in the next stage (S88).

With the processing described above, it is possible to construct a data spreading/stuffing shifter including a control circuit with a circuit size of O(N log N).

As described above, embodiments of the present invention have been described in detail. However, aside from an information processing apparatus, it is possible for the embodiments to involve a method in which a computer executes the above processing or as a program on a storage medium in which the program is stored.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

1-12. (canceled)

13. A data shifter configured to perform data shift operations on N-lane data sequences, the data shifter comprising a plurality of stages, each of which includes N elemental units, wherein the mth elemental unit included in the pth stage is preliminarily assigned a predetermined one-bit value c and a positive integer q, and comprises:
a first input circuit configured to input target data to be processed whose size is greater than or equal to one bit;
a second input circuit configured to input destination data representing a lane number of a lane where Data (p,m), a logical OR of the input target data, should be routed to, the size of the destination data being ┌log₂ N┐ bit(s);
a comparison circuit configured to compare the qth bit from the least significant bit of Des (p,m), a logical OR of the input destination data, with the one-bit value c; and
an output circuit configured to output, based on the comparison result, both one of Data (p,m) and the value 0 as the target data and one of Des (p,m) and the value 0 as the destination data bound for the mth elemental unit included in the next stage, and, if m−1+2^{q-1}<N, to output both the other of Data (p,m) and the value 0 as the target data and the other of Des (p,m) and the value 0 as the destination data bound for the (m+2^{q-1}) th elemental unit included in the next stage;
wherein the plurality of stage and the N element units of each stage are arranged to input both the N-lane data sequences to be processed as the target data and the destination data of each said data sequence into the N elemental units included in the first stage respectively, and to output, as shifted output data of the mth lane, a logical OR of the target data which the elemental units included in the last stage output bound for the mth elemental unit included in the next stage.

14. The data shifter of claim 13, wherein the output circuit is configured to perform output according to two cases, depending upon whether or not the qth bit from the least significant bit of Des (p,m) matches the bit value c:
wherein if the qth bit from the least significant bit of Des (p,m) does match the one-bit value c, both Data (p,m) as the target data and Des (p,m) as the destination data are output bound for the mth elemental unit included in the next stage, and if m−1+2^{q-1}<N, both the value 0 as the target data and the value 0 as the destination data are further output bound for the (m+2^{q-1}) th elemental unit included in the next stage, else
wherein if the qth bit from the least significant bit of Des (p,m) does not match the one-bit value c, both the value 0 as the target data and the value 0 as the destination data are output bound for the mth elemental unit included in the next stage, and if m−1+2^{q-1}<N, both Data (p,m) as the target data and Des (p,m) as the destination data are further output bound for the (m+2^{q-1}) th elemental unit included in the next stage.

15. The data shifter of claim 14, wherein the bit width of each lane data of the N-lane data sequences is identical.

16. The data shifter of claim 14, wherein the number of the stages is ┌log₂ N┐.

17. The data shifter of claim 14, wherein q=┌log₂ N┐−p+1, and the one-bit value c assigned to the mth elemental unit included in the pth stage is the pth bit from the most significant bit of the (m)₂.

18. The data shifter of claim 14, wherein q=p, and the one-bit value c assigned to the mth elemental unit included in the pth stage is the pth bit from the least significant bit of the (m)₂.

19. A multiplexer for a first data sequence and a second data sequence comprising:
a spreading circuit configured to spread each of the first and the second data sequences, using a data shifter according to claim 17; and
a computation circuit configured to compute a logical OR of the spread first data sequences and the spread second data sequences.

20. A data sifter configured to sift each data element Data (m) included in an input data sequence into two groups based on a sort key K(m) corresponding to said data element Data (m) and a predetermined decision function f(K(m)) which takes the sort key K(m) as an input and outputs a value selected from two candidates X and Y, the data sifter comprising:
a first collection circuit configured to collect data element(s) corresponding to the sort key(s), where the decision function f(K(m)) outputs a value X, from the data elements included in the input data sequence, using a data shifter according to claim 18, to output a first data sequence; and
a second collection circuit configured to collect data element(s) corresponding to the sort key(s) where the function f(K(m)) outputs a value Y, from the data elements included in the input data sequence, with use of the data shifter, to output a second data sequence.

21. The data sifter of claim 20, wherein the sort keys corresponding to the data elements are the value of said data elements themselves.

22. A data sorter that sorts each data element included in an input data sequence, the data sorter comprising:
a sorter input circuit configured to sort each data element included in the input data sequence into a data sifter according to claim 20, in order to acquire two sequences of data elements;
a control circuit configured to perform control to repeatedly input each data element included in the two independent data sequences into the data sifter, so all of the data elements included in the input data sequence are sorted.

23. A data sorter that sorts each data element included in an input data sequence, the data sorter comprising a plurality of data sifters according to claim 20, wherein the plurality of data sifters includes one data sifter that inputs the input data sequence as a target data sequence, and wherein each of the plurality of the data sifters is configured to:
input a target data sequence,
sift the target data sequence into a first and a second data sequence based on the decision function preliminarily assigned to said data sifter,
output the first and/or second data sequence that include(s) more than one data elements to another data sifter(s) as the target data sequence, and
output the first and/or second data sequence that include(s) only one data element as the sorting result.

24. A control method of a data shifter that comprises a plurality of stages each of which includes N elemental units to perform data shift operations on N-lane data sequences, wherein the mth elemental unit included in the pth stage is preliminarily assigned a predetermined one-bit value c and a positive integer q, the method comprising, for each shifter:
inputting target data to be processed whose size is greater than or equal to one bit;
inputting destination data representing a lane number of a lane where Data (p,m), a logical OR of the input target data, should be routed to, the size of the destination data being ┌log₂ N┐ bit(s);
comparing the qth bit from the least significant bit of Des (p,m), a logical OR of the input destination data, with the one-bit value c; and
outputting, based on the comparison result, both one of Data (p,m) and the value 0 as the target data and one of Des (p,m) and the value 0 as the destination data bound for the mth elemental unit included in the next stage, and, if m−1+2^{q-1}<N, further outputting both the other of Data (p,m) and the value 0 as the target data and the other of Des (p,m) and the value 0 as the destination data bound for the (m+2^{q-1}) th elemental unit included in the next stage; and
the method further comprising, for the data shifter:
inputting both the N-lane data sequences to be processed as the target data and the destination data of each said data sequence into the N elemental units included in the first stage respectively, and
outputting, as shifted output data of the mth lane, a logical OR of the target data which the elemental units included in the last stage output bound for the mth elemental unit included in the next stage.

25. A data shifter which performs data shift operations on N-lane data sequences, the data shifter comprising a plurality of stages, each of which includes N elemental units, wherein the mth elemental unit included in the pth stage is preliminarily assigned a predetermined one-bit value c and a positive integer q, and comprises:
means for inputting target data to be processed whose size is greater than or equal to one bit;
means for inputting destination data representing a lane number of a lane where Data (p,m), a logical OR of the input target data, should be routed to, the size of the destination data being ┌log₂ N┐ bit(s);
means for comparing the qth bit from the least significant bit of Des (p,m), a logical OR of the input destination data, with the one-bit value c; and
means for outputting, based on the comparison result, both one of Data (p,m) and the value 0 as the target data and one of Des (p,m) and the value 0 as the destination data bound for the mth elemental unit included in the next stage, and, if m−1+2^{q-1}<N, further outputting both the other of Data (p,m) and the value 0 as the target data and the other of Des (p,m) and the value 0 as the destination data bound for the (m+2^{q-1}) th elemental unit included in the next stage,
inputting both the N-lane data sequences to be processed as the target data and the destination data of each said data sequence into the N elemental units included in the first stage respectively, and
outputting, as shifted output data of the mth lane, a logical OR of the target data which the elemental units included in the last stage output bound for the mth elemental unit included in the next stage.

26. The data shifter of claim 24, wherein the means for outputting performs output divided into two cases depending upon whether or not the qth bit from the least significant bit of Des (p,m) matches the bit value c:
wherein if the qth bit from the least significant bit of Des (p,m) does match the one-bit value c, both Data (p,m) as the target data and Des (p,m) as the destination data are output bound for the mth elemental unit included in the next stage, and if m−1+2^{q-1}<N, both the value 0 as the target data and the value 0 as the destination data are further output bound for the (m+2^{q-1}) th elemental unit included in the next stage, else
wherein if the qth bit from the least significant bit of Des (p,m) does not match the one-bit value c, both the value 0 as the target data and the value 0 as the destination data are output bound for the mth elemental unit included in the next stage, and if m−1+2^{q-1}<N, both Data (p,m) as the target data and Des (p,m) as the destination data are further output bound for the (m+2^{q-1}) th elemental unit included in the next stage.

27. The data shifter of claim 26, wherein the bit width of each lane data of the N-lane data sequences is identical.

28. The data shifter of claim 26, wherein the number of the stages is ┌log₂ N┐.

29. The data shifter of claim 26, wherein q=┌log₂ N┐−p+1, and the one-bit value c assigned to the mth elemental unit included in the pth stage is the pth bit from the most significant bit of the (m)₂.

30. The data shifter of claim 26, wherein q=p, and the one-bit value c assigned to the mth elemental unit included in the pth stage is the pth bit from the least significant bit of the (m)₂.

31. A multiplexer for a first data sequence and a second data sequence comprising:
spreading means for spreading each of the first and the second data sequences with use of a data shifter according to claim 28; and
computation means for computing a logical OR of the spread first data sequences and the spread second data sequences.

32. A data sifter which sifts each data element Data (m) included in an input data sequence into two groups based on a sort key K(m) corresponding to said data element Data (m) and a predetermined decision function f(K(m)) which takes the sort key K(m) as an input and outputs a value selected from two candidates X and Y, comprising:
first collection means for collecting data element(s) corresponding to the sort key(s) where the decision function f(K(m)) outputs a value X, from the data elements included in the input data sequence, with use of a data shifter according to claim 30, to output a first data sequence; and
second collection means for collecting data element(s) corresponding to the sort key(s) where the function f(K(m)) outputs a value Y, from the data elements included in the input data sequence, with use of the data shifter according to claim 30, to output a second data sequence.

33. The data sifter of claim 32, wherein the sort keys corresponding to the data elements are the value of said data elements themselves.

34. A data sorter configured to sort each data element included in an input data sequence, the data sorter comprising:
inputting means for inputting each data element included in the input data sequence into a data sifter according to claim 32 in order to acquire two sequences of data elements;
control means for performing control to repeatedly input each data element included in the two independent data sequences into the data sifter, so that all of the data elements included in the input data sequence are sorted.

35. A data sorter configured to sort each data element included in an input data sequence, the data sorter comprising a plurality of data sifters according to claim 32,
wherein the plurality of data sifters includes one data sifter that inputs the input data sequence as a target data sequence, and
wherein each of the plurality of the data sifters is configured to:
input a target data sequence,
sift the target data sequence into a first and a second data sequence based on the decision function preliminarily assigned to said data sifter,
output the first and/or second data sequence that include(s) more than one data elements to another data sifter(s) as the target data sequence, and
output the first and/or second data sequence that include(s) only one data element as the sorting result.
